(19) United States
(12) Patent Application Publication
(10) Pub. No.: US 2015/0257168 A1
(43) Pub. Date: Sep. 10, 2015

(54) METHOD FOR CONTROLLING PACKET PRIORITY, ACCESS POINT AND COMMUNICATIONS SYSTEMS THEREOF

(71) Applicant: Accton Technology Corporation, Hsinchu City (TW)

(72) Inventor: Tan-Chun LU, New Taipei City (TW)

(73) Assignee: Accton Technology Corporation, Hsinchu City (TW)

(21) Appl. No.: 14/199,591

(22) Filed: Mar. 6, 2014

(51) Int. Cl. H04W 72/10; H04W 28/02

(52) U.S. Cl. CPC H04W 72/10; H04W 28/0268; H04W 72/1247

(57) ABSTRACT

A method for controlling packet priority is disclosed. The method is used in an access point and includes: associating with a station (STA) by a virtual access point (VAP) of an access point (AP), wherein an packet priority queue is applied in the STA initially; transmitting a configuration beacon frame to the STA by the VAP; reconfiguring the packet priority queue of the STA according to the configuration beacon frame; and transmitting an uplink data packet by the STA following the packet priority queue of the STA after receiving the configuration beacon frame from the VAP.

### BACKGROUND OF THE INVENTION

1. Field of the Invention

Aspects of the present invention relate generally to wireless communications systems, and more particularly, to methods, access points and communications systems for controlling packet priority.

2. Description of the Related Art

Wi-Fi Multimedia (WMM) and IEEE 802.11e standard specifications are extensions of Institute of Electrical and Electronics Engineers (IEEE) 802.11 in an aspect of Quality of Service (QoS). In a case where the bandwidth is limited in a Wireless Local Area Network (WLAN) environment, only Enhanced Distributed Channel Access (EDCA) QoS in IEEE 802.11e can meet the requirements for the transmission of data services.

In the IEEE 802.11e standard, there are four access category queues, Background traffic, Best Effort traffic, Video traffic and Audio traffic, which can configure different EDCA parameters to provide the queue having the highest priority with more opportunities for transmitting the packets and a decrease of the wait time of the queue.

The WMM test plan uses a specific application (Ixia Chariot) to generate the packets with specific user priority (UP), so that the packet priority may take effect in the air for the uplink traffic. In addition, the 802.1p (in VLAN tag) or TOS (in IP header) is used to assign the packet priority in the downlink traffic. However, most wireless stations (STA) and handheld device applications may not assign a priority to the uplink traffic.

Therefore, there is a need for a method, access point and communications system for controlling packet priority during communications between the STA and the AP, so that the STA uplink traffic (from the STA to the AP) can take effect in the air.

### BRIEF SUMMARY OF THE INVENTION

A detailed description is given in the following embodiments with reference to the accompanying drawings.

Methods, access points and communications systems for controlling packet priority are provided.

In one exemplary embodiment, the invention is directed to a method for controlling packet priority, used in a communications system, comprising: associating with a station (STA) by a virtual access point (VAP) of an access point (AP), wherein an packet priority queue is applied in the STA initially; transmitting a configuration beacon frame to the STA by the VAP; reconfiguring the packet priority queue of the STA according to the configuration beacon frame; and transmitting an uplink data packet by the STA following the packet priority queue of the STA after receiving the configuration beacon frame from the VAP.

In one exemplary embodiment, the invention is directed to a communications system for controlling packet priority, at least comprising: a station (STA), wherein an packet priority queue applied in the STA initially; an access point (AP), at least comprising: a virtual access point (VAP), configured to perform communication with the STA, wherein the VAP associates with the STA and transmits a configuration beacon frame to the STA; the STA reconfigures the packet priority queue of the STA according to the configuration beacon frame, and the STA transmits an uplink data packet following the packet priority queue of the STA after receiving the configuration beacon frame from the VAP.

In one exemplary embodiment, the invention is directed to an access point (AP) for controlling packet priority, comprising: a control circuit; a processor installed in the control circuit; a memory installed in the control circuit and operatively coupled to the processor; wherein the processor is configured to execute a program code stored in the memory to: associate with a station (STA); transmit a configuration beacon frame to the STA, wherein the configuration beacon frame is used for reconfiguring a packet priority queue of the STA; and receive an uplink data packet from the STA following the packet priority queue of the STA.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram illustrating a wireless communications system according to an exemplary embodiment of the present invention.

FIG. 2 is a schematic diagram illustrating a priority queue configuration of the station (STA) according to one embodiment of the present invention.

FIG. 3 is a functional block diagram of a communications device according to one exemplary embodiment.

FIG. 4 is a functional block diagram of the program code of FIG. 3 according to one exemplary embodiment.

FIG. 5 is a flow diagram illustrating a method for controlling packet priority according to the embodiment of the present invention.

FIG. 6 is a flow diagram illustrating a method for controlling packet priority according to the embodiment of the present invention.

### DETAILED DESCRIPTION OF THE INVENTION

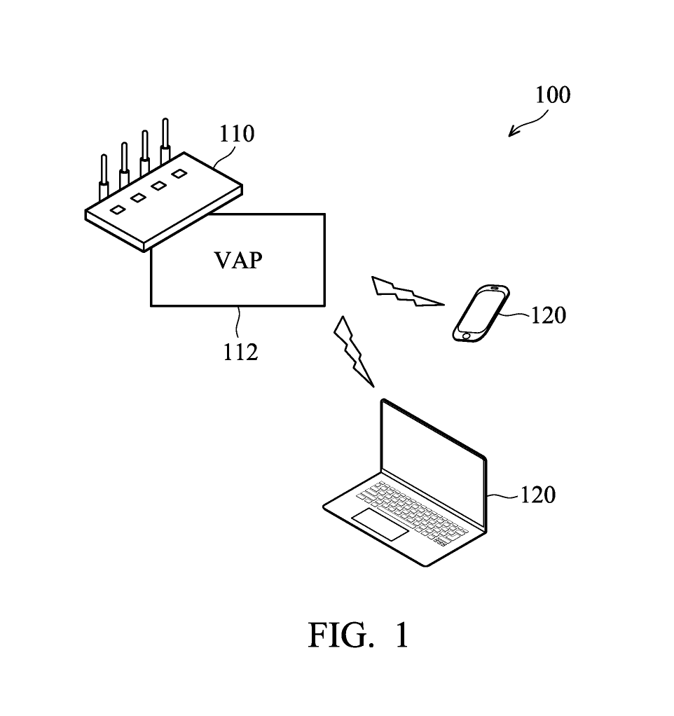

Several exemplary embodiments of the present disclosure are described with reference to FIGS. 1 through 6, which generally relate to a method for controlling packet priority, an access point and a communications system thereof. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

According to an embodiment of the present invention, a single physical Access Point (AP) functions as a plurality of virtual APs corresponding to a plurality of groups classified in order to provide different network services. A station seeking to be newly provided with a service receives beacons periodically transmitted from the AP, and the AP is associated with the virtual AP to which the new station corresponds. Once an association is made, the station listens to control packets issued only from its virtual AP, ignoring control packets from other virtual APs. Accordingly, the stations of each group can be collectively controlled via AP virtualization.

FIG. 1 is a schematic diagram 100 illustrating a wireless communications system according to an exemplary embodiment of the present invention.

As shown in FIG. 1, the wireless communications system 100 according to the embodiment of the present invention includes a single AP 110 and at least one station (STA) 120. The AP 110 includes a virtual access point (VAP) 112, wherein the VAP 112 is set by the AP 110 to perform communication with the STA 120 for providing the wireless local area network (WLAN) services.

The wireless communications system 100 may be used in a wireless network. The wireless network may be a local area network, a wide area network, or an IEEE 802.11 type of network, and provides access to different services such as Telephony, Television, and the Internet. The AP 110 may refer to any type of infrastructure node, such as a base station, node B, relay station, mesh point, etc. The STA 120 may be a wireless network client, a desktop computer, laptop, mobile device, cell phone, or personal digital assistant, a mobile communications device or the like. The STA 120 conforms to the IEEE 802.11 standard to define an hardware queue for the background traffic, best effort traffic, video traffic and audio traffic during communications initially, but not limited.

In an exemplary embodiment, the VAP 112 broadcasts a beacon frame including different control information to the STAs therearound. The STA 120 (having the control information) may send an association request to the VAP 112, wherein a packet priority queue is applied in the STA 120 initially. The VAP 112 may respond by sending an association response to the station 120 and associate with the station 120. The VAP 112 transmits a configuration beacon frame to the STA 120 after associating with the station 120, wherein the configuration beacon frame comprises a priority queue configuration corresponding to a priority queue configuration of the VAP. The station 120 may reconfigure the packet priority queue according to the priority queue configuration and transmit an uplink data packet to the VAP 112 following the modified packet priority queue of the STA after receiving the configuration beacon frame.

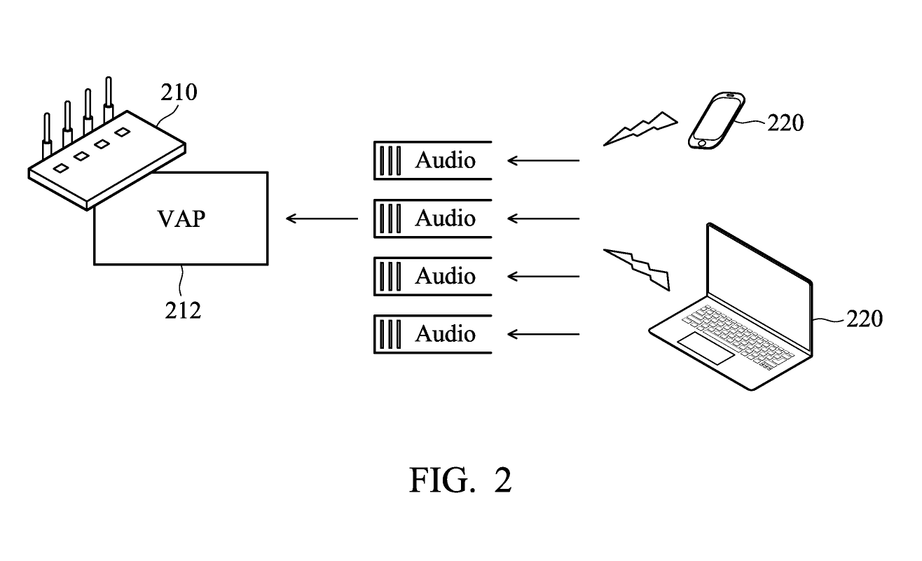

In addition, the priority queue configuration can be set by the VAP, wherein the priority queue configuration may be associated with 4 queue EDCA parameters defined in 802.11e, which are background priority, best effort priority, video priority and audio priority, detailed information concerning to the queue EDCA parameters please refer to IEEE 802.11e standard, and will not be repeated accordingly. Referring to FIG. 2, for example, the priority queue configuration of the STA 220 can be set by the VAP 212. If the priority queue configuration of the STA 220 is configured as audio priority, all the queue parameters of the STA 220 can be set to the same parameter as the audio queue by the VAP 212. The STA 220 reconfigures its hardware queues according to the priority queue configuration after the STA 220 associates with the VAP 212. Finally, the STA 220 can transmit an uplink data packet to the VAP 212 according to the priority queue configuration. Therefore, the packets from the STA application will take effect with the audio priority, no matter which hardware queues were used by the STA 220 before.

In another embodiment, when the AP 210 boots up, the VAP 212 can read the priority queue configuration from a memory of the AP 210, and then configures the hardware queues. The hardware queues of the STA 220 may get/follow the hardware queues of the VAP 212 after the STA 220 associates with the VAP 212. In other words, the priority queue configuration of the STA 220 may correspond to the priority queue configuration of the VAP 212.

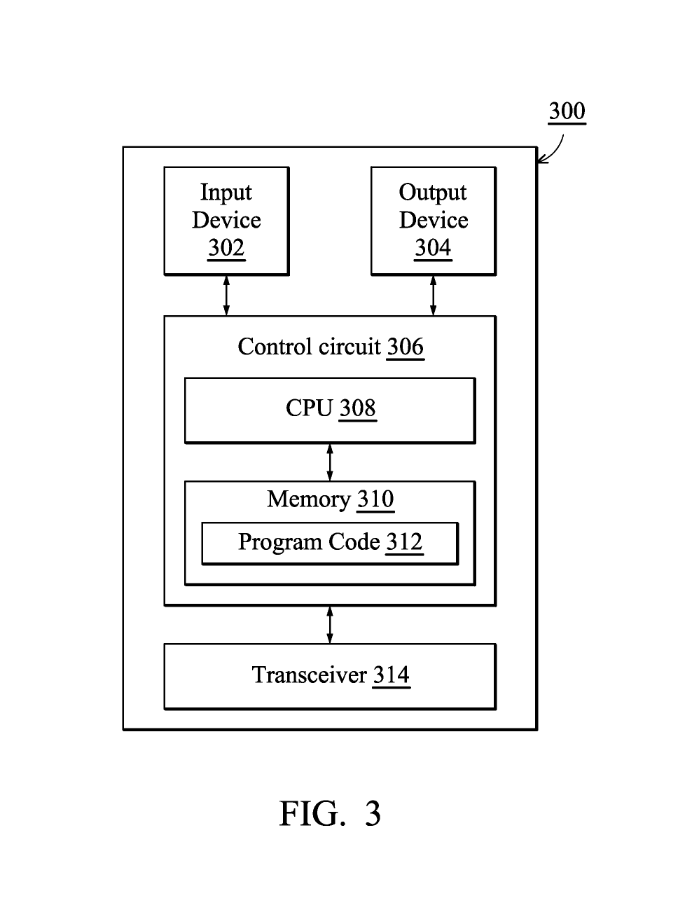

FIG. 3 is a block diagram illustrating a communications device according to an embodiment of the invention. The communications device as shown in FIG. 3 may be included in the AP and the STA supporting the VAP in the exemplary embodiment of the present invention.

Turning to FIG. 3, the communications device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the wireless device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and wirelessly outputting signals generated by the control circuit 306.

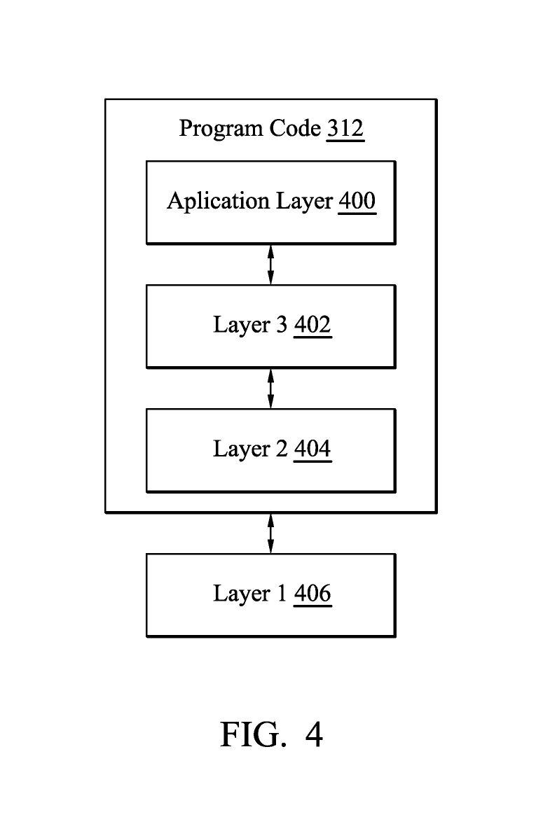

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

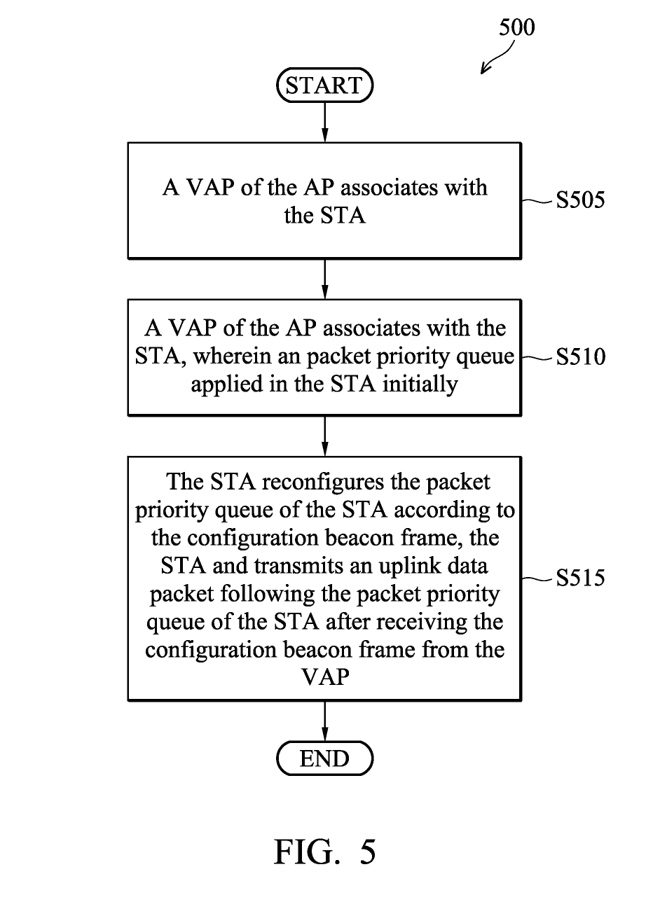

FIG. 5 is a flow diagram illustrating a method 500 for controlling packet priority according to the embodiment of the present invention. It is noted that the method 500 is used in a communications system. The communications system comprises at least an access point (AP) and at least one station (STA). First, in step S505, a virtual access point (VAP) of the AP associates with the STA, wherein a packet priority queue applied in the STA initially. Then, in step S510, the VAP transmits a configuration beacon frame to the STA. Finally, in step S515, the STA reconfigures the packet priority queue of the STA according to the configuration beacon frame, the STA and transmits an uplink data packet following the packet priority queue of the STA after receiving the configuration beacon frame from the VAP.

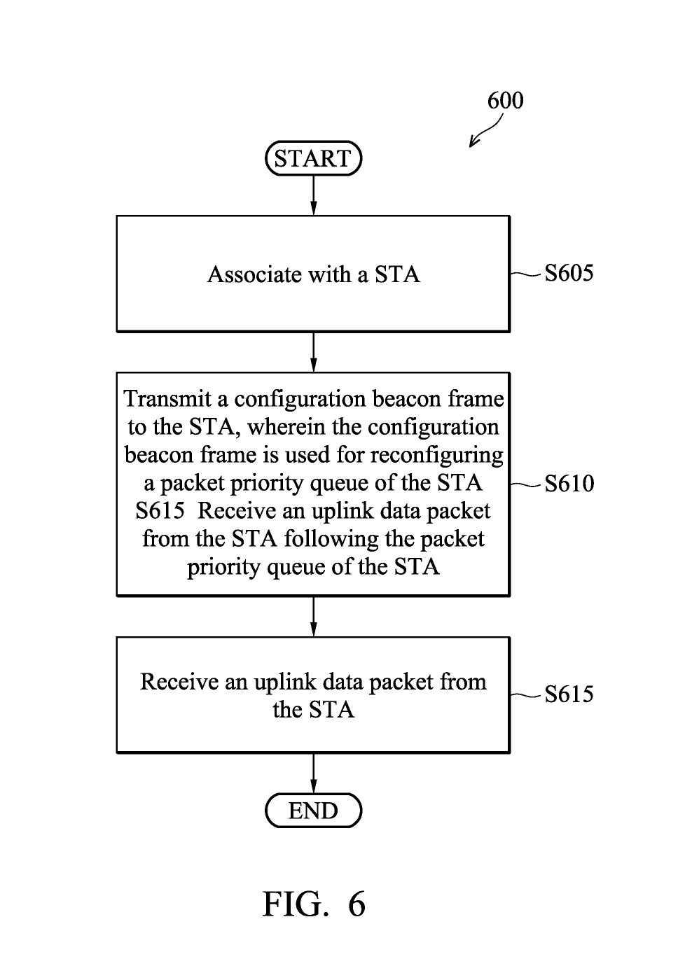

FIG. 6 is a flow diagram illustrating a method 600 for controlling packet priority according to the embodiment of the present invention. It is noted that the method 500 is performed by an access point (AP). The AP may support at least one virtual access point (VAP). First, in step S605, the AP associates with a station (STA). Then, in step S610, the AP transmits a configuration beacon frame to the STA, wherein the configuration beacon frame is used for reconfiguring a packet priority queue of the STA. Finally, in step S615, the AP receives an uplink data packet from the STA following the packet priority queue of the STA.

In another embodiment, the AP may configure different packet priority queues for different STAs in advance. It is to say that when one STA associates with the AP, the AP may classify the STA into a group, such as group A, according to control information of the STA, such as a media access control (MAC) address; in this aspect, the AP may classify another STA into a different group, such as group B. The AP obtains the packet priority queues corresponding to each group and transmits a configuration beacon frame including the packet priority queue to each STA respectively, each STA receives the configuration beacon frame and reconfigures the packet priority queue of the STA according to the configuration beacon frame, and each STA transmits an uplink data packet following the packet priority queue of the STA after receiving the configuration beacon frame from the VAP. Hence, each STA in different groups may transmit the uplink packet to the AP in various priority queues respectively according to the configuration beacon frame to achieve different communication purposes.

Referring back to FIGS. 3 and 4, the communications device 300 could include a program code 312 stored in memory 310 to implement the methods for controlling packet priority. The CPU 308 could execute the program code 312 to perform all of the above-described actions and steps in FIGS. 5-6 or others described herein.

According to the exemplary embodiments of the present invention, the STA may use the queue configuration set by the VAP. Therefore, the packets transmitted from the STA may take effect in the air (from the STA to the AP).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for controlling packet priority, used in a communications system, comprising:
associating with a station (STA) by a virtual access point (VAP) of an access point (AP), wherein an packet priority queue is applied in the STA initially;
transmitting a configuration beacon frame to the STA by the VAP;
reconfiguring the packet priority queue of the STA according to the configuration beacon frame; and
transmitting an uplink data packet by the STA following the packet priority queue of the STA after receiving the configuration beacon frame from the VAP.

2. The method for controlling packet priority as claimed in claim 1, wherein the configuration beacon frame comprises a priority queue configuration corresponding to a priority queue configuration of the VAP.

3. The method for controlling packet priority as claimed in claim 1, wherein the priority queue configuration is associated with a plurality of access parameters among background priority, best effort priority, video priority and audio priority, the STA reconfigures the packet priority queue according to the priority queue configuration.

4. A communications system for controlling packet priority, at least comprising:
a station (STA), wherein an packet priority queue is applied in the STA initially;
an access point (AP), at least comprising:
a virtual access point (VAP), configured to perform communication with the STA,
wherein the VAP associates with the STA and transmits a configuration beacon frame to the STA, the STA reconfigures the packet priority queue of the STA according to the configuration beacon frame, and the STA transmits an uplink data packet following the packet priority queue of the STA after receiving the configuration beacon frame from the VAP.

5. The communications system for controlling packet priority as claimed in claim 4, wherein the configuration beacon frame comprises a priority queue configuration corresponding to a priority queue configuration of the VAP.

6. The communications system for controlling packet priority as claimed in claim 4, wherein the priority queue configuration is associated with a plurality of access parameters among background priority, best effort priority, video priority and audio priority, the STA reconfigures the packet priority queue according to the priority queue configuration.

7. An access point (AP) for controlling packet priority, comprising:
a control circuit;
a processor installed in the control circuit;
a memory installed in the control circuit and operatively coupled to the processor;
wherein the processor is configured to execute a program code stored in the memory to:
associate with a station (STA);
transmit a configuration beacon frame to the STA, wherein the configuration beacon frame is used for reconfiguring a packet priority queue of the STA; and
receive an uplink data packet from the STA following the packet priority queue of the STA.

8. The access point for controlling packet priority as claimed in claim 7, wherein the processor is configured for:
setting a virtual access point to perform communication with the STA.

9. The access point for controlling packet priority as claimed in claim 7, wherein the configuration beacon frame comprises a priority queue configuration corresponding to a priority queue configuration of the VAP.

10. The access point for controlling packet priority as claimed in claim 7, wherein the priority queue configuration is associated with a plurality of access parameters among background priority, best effort priority, video priority and audio priority, the STA reconfigures the packet priority queue according to the priority queue configuration.
